(19) United States
(12) Patent Application Publication
(10) Pub. No.: US 2015/0129675 A1
(43) Pub. Date: May 14, 2015

(54) IRRIGATION SYSTEM AND METHOD

(71) Applicants: GIUSEPPE SERENELLI, VERONA (IT); LORENZO SIMONI, FAVARO VENETO DI VENEZIA (IT)

(72) Inventors: GIUSEPPE SERENELLI, VERONA (IT); LORENZO SIMONI, FAVARO VENETO DI VENEZIA (IT)

(21) Appl. No.: 14/540,049

(22) Filed: Nov. 13, 2014

(30) Foreign Application Priority Data
Nov. 13, 2013 (IT) VI2013A000272

(51) Int. Cl. A01C 23/04; A01M 7/00; A01C 23/00

(52) U.S. Cl. CPC A01C 23/042; A01C 23/008; A01C 23/047; A01M 7/0025; A01M 7/0092
USPC 239/10; 239/302; 239/310

(57) ABSTRACT

The invention concerns an irrigation system (2) comprising a tank (4) in its turn provided with a water feeding inlet (6), a water outlet (8), and optionally a closing element (10), and comprising a sprinkling unit (12) provided with a water inlet opening (14) and a water outlet jet (16), as well as a connection element (18) suited for transferring a liquid. The inlet opening (14) of the sprinkling unit (12) is connected, with respect to the direction of said water flow, downstream of the tank (4) through the connection element (18) with the outlet (8) of the tank (4), in such a way that the water flowing out of the tank (4) enters the sprinkling unit (12) through the inlet opening (14). The invention concerns also a corresponding irrigation plant and method and a corresponding dispenser tank. The invention can be applied for treating different types of soil, in particular agricultural areas, gardens and flower beds, and sports grounds.

### CROSS REFERENCE TO RELATED PATENT APPLICATIONS

To the fullest extent permitted by law, this nonprovisional utility patent application claims priority under 35 U.S.C. §119 to Italy Patent Application No. VI2013A000272, with a filing date of Nov. 13, 2013.

### STATEMENT REGARDING FEDERALLY-SPONSORED RESEARCH OR DEVELOPMENT

Not applicable.

### FIELD OF THE INVENTION

The invention concerns an irrigation system, an irrigation plant, an irrigation method and a corresponding dispenser tank as well as their use, which allow land, like for example golf courses, gardens, meadows in general to be treated with fertilizing agents and/or active principles such as insecticides, herbicides, pesticides, etc.

### BACKGROUND OF THE INVENTION

The irrigation and treatment of large pieces of land, for example golf courses, require large irrigation systems with many irrigators or the use of tractors with tank trucks containing fertilizing solutions or other substances that are useful in order to treat the soil, so that these large pieces of land can be irrigated or treated.

A wide range of irrigators for soil irrigation are available on the market, and said irrigators can be arranged in various points on the ground and connected to one another in such a way as to cover the entire surface of the same. Such an irrigation system known in the art and generally indicated by reference number 822 is shown in FIG. 5a, in which secondary pipes 825 depart from a main pipe 828, said secondary pipes 825 being suited to be separated from the main pipe by means of solenoid valves 830. Each secondary pipe is provided with irrigators 814 that are spaced from one another at specific intervals. Each secondary pipe 825 forms, together with the corresponding irrigators 814, an irrigation sector 826 of the irrigation system. The system feeding unit (usually comprising a pump) is indicated by reference number 824.

In order to combine soil irrigation with treatments based on fertilizers or other chemical compounds, and in order to avoid the use, for example, of tractors with tank trucks, systems have been developed that are provided with a traditional irrigation network, wherein, for example, a fertilizing solution is injected in the water flow inside this network and then conveyed to the various irrigators. This injection system requires the use of large tanks in order to contain sufficient quantities of fertilizers or other chemical compounds and thus be able to feed the entire network, and furthermore requires the use of devices suited to mix the injected substances with the water contained in the network in order to avoid differences in concentration. In the case of limited injection volumes, on the one hand it is necessary to use highly concentrated solutions characterized by high toxicity, while on the other hand small volumes involve the risk of big mistakes that could be made when dispensing the solution containing the chemical substance to be distributed on the ground. It cannot be neglected that injection systems need a complex structure to determine the correct quantities of fertilizer to be added into the network. Usually the system determines the quantity of fertilizer to be added based on the measured water flow, and this process must be managed through another complex system that successively activates the addition of the chemical compound. With the existing systems, furthermore, it is not possible to intervene only on specific areas, even if they are small.

### BRIEF SUMMARY OF THE INVENTION

One object of the present invention is to provide an irrigation system that overcomes the drawbacks described above, is simple from the point of view of construction and does not require the use of complex structures to add suitable quantities of fertilizer, insecticide, herbicide, etc. into the irrigation water, so that it is possible to use the irrigation water for fertilization and at the same time also for other soil treatments. It is a further object of the invention to provide a corresponding irrigation plant, a corresponding irrigation method and a corresponding dispenser tank.

The objects described above and others that are illustrated in greater detail below are achieved by an irrigation system as defined in the first claim, meaning an irrigation system comprising:

(a) a tank comprising

(a1) a water feeding inlet,

(a2) a water outlet, and

(a3) optionally a closing element;

(b) a sprinkling unit comprising

(b1) a water feeding inlet opening, and

(b2) a water outlet jet; and

(c) a connection element suited to transfer a liquid,
wherein the inlet opening of the sprinkling unit is connected to the outlet of the tank downstream of the tank itself, in the direction of the water flow being fed, through the connection element, so that the water flowing out of the tank enters the sprinkling unit through the inlet opening.

The system comprises two elements, a sprinkling unit and a tank. The sprinkling unit can preferably be a simple chamber provided with several nozzles for letting the water out, a perforated pipe, or for example one of the several irrigators with directable or non-directable, automatic or non-automatic jet that are known in the market. Advantageously, the tank is a simple chamber with two openings, one serving as an inlet and one serving as an outlet. The tank serves to contain a fertilizing agent and/or an active principle to be added into the irrigation water. The irrigation water flowing into the tank, for example, dissolves a fertilizing agent contained in a tablet placed in the tank, thus producing a fertilizer solution. The water flowing out of the tank contains the dissolved fertilizing agent. The tank thus serves as a dispenser for the fertilizing agent, as in this case, or for another active principle. Advantageously, the flow itself produces a sufficient mixing action. Successively, the water with the addition of the fertilizing agent and/or active principle flows into the irrigation unit with no need for complex injection system, thanks to the simple principle according to which a tank is inserted in the water flow before the water enters the sprinkling unit. Advantageously, the tank serves as a continuous flow device. The fertilizing agent and/or active principle can be introduced in the tank through the tank inlet or outlet. However, the tank preferably comprises also a closing element, for example a cover, which allows easy access to the inside of the tank with no need to remove it from the irrigation system in order to fill it.

The presence of a tank makes it possible to introduce a fertilizing agent and/or an active principle in a simple structure suited to contain it, with no need to disassemble complex mechanisms with the risk of damaging them. The automatic passage of the irrigation water through the tank, in which a fertilizer tablet can be placed, for example, makes it possible to add the fertilizer or other compounds without using devices that calculate the quantity to be added (if necessary based on further expensive measurements) and activate the addition process.

The system according to the invention makes it possible to avoid the use of complex injection systems that are often subject to obstructions or other failures.

The simple structure makes it possible to use components that are already available on the market and just need to be assembled according to the invention.

The connection can be a direct connection, like for example obtained by means of a rigid pipe or a flexible pipe, but also an indirect connection, for example obtained by means of pipes provided with further sprinkling units (in this way several sprinkling units can be fed with one tank) or by means of valves or further tanks.

Advantageously, the sprinkling unit is connected to the tank in such a way that the sprinkling unit is fed only with the water flowing out of the tank. This ensures that the sprinkling unit receives only water containing additives in a specific concentration and that further mixing operations with water from other sources feeding the sprinkling unit are not necessary, and furthermore offers the easiest possible connection between the sprinkling unit and the tank.

Advantageously, the sprinkling unit can be an irrigator of any model available on the market that must simply be connected to the tank according to the invention. The number and size of jet nozzles, the possibility to direct the jet, the type and number of jets used, etc. can vary. Advantageously, in order to obtain an irrigation system according to the invention it is not necessary to modify the sprinkling unit or an irrigator known in the art, in fact it is sufficient to connect a simple tank upstream of the system.

Preferably, the connection between the tank and the sprinkling unit is made in a removable way. This makes it possible to replace sprinkling units and/or defective tanks with no problems, to assemble a combination of tanks and sprinkling units according to the needs, to replace the tank with another one in a different size, etc.

The irrigation system according to the invention does not need the specific separate preparation of solutions containing fertilizing agents and/or active principles as in the case of injection systems, since the solution is prepared automatically exploiting the flow through the tank, with no need to resort to special measures to prepare the solutions externally to the main flow of irrigation water.

According to a preferred embodiment of the invention, the tank contains at least one tablet comprising a fertilizing agent and/or an active principle essentially soluble in water. In this context, a tablet is preferably to be understood as a solid element containing a single predefined quantity of one or more fertilizing agents and/or active principles, generally obtained through compression of a volume of particles (usually powders). It can also contain further substances, for example a suitable excipient. As water flows through the tank, a given quantity of fertilizing agent and/or active principle is dissolved in it and for example produces, in the case of a fertilizing agent, a fertilizer solution that then is conveyed to the sprinkling unit in order to irrigate the soil. The tablet will dissolve according to the water flow rate, the composition of the tablet and the duration of the water flow through the tank. Compared to injection systems, in which a solution containing a fertilizing agent and/or an active principle must already be present, in this case the solution is produced “just-in-time”, avoiding the decomposition of the fertilizing agent and/or the active principle in the solution during system idle times and avoiding the formation of concentration gradients inside the solution over time, which would result in the injection of uncontrollable quantities. For this purpose, the market offers a wide choice of tablets for use in agriculture or gardening, for example with different fertilizer concentrations. It is possible to use the water flow rate and the duration of the irrigation cycle to easily affect the quantities of fertilizing agent and/or active principle that actually reach the soil. Advantageously, in the case where tablets are used, the tank does not need to be provided with separation devices at the outlet, as the fertilizing agent and/or the active principle can enter the irrigation plant only in the moment when an irrigation cycle is being carried out. On the contrary, in the case of injection systems the fertilizing liquid and/or the liquid with the addition of an active principle may, in the absence of separation devices, get into the irrigation plant at any moment, leading to an uncontrollable distribution of fertilizing agent and/or active principle inside the irrigation plant.

If a user desires to treat the soil with different agents, for example a fertilizer and an insecticide in order to eliminate, for example, mosquitos, the tank can be fed with two different tablets in succession or at the same time. The tablets can have different shapes and sizes without departing from the basic principles of the invention. It is also possible to consider the option to arrange several tanks containing different tablets in series upstream of the sprinkling unit. The tablets can also be small-sized, in such a way as to form a loose material in granules. In this way, the tank is not filled with a single large tablet or several large tablets, but with a bed of small tablets. The sizes are conditioned by the dissolution speed and by the degree of difficulty in separating the tablet from the rest of the irrigation system. The use of powders would lead, for example, to the need to provide the inlet and the outlet of the tank with filters that prevent solid material from being let out. The concentration of the active principle inside the irrigating solution can also be varied by using more than one tablet or varying the concentration of active principle in the tablet itself.

The use of tablets makes it possible to reduce the size of the tank compared to a tank for liquids. Placing the tablet in a separate tank means avoiding any demanding operation on complex parts of the irrigation system to insert a tablet, which can often be performed only by an expert or which requires a lot of time, for example if the tablet needs to be introduced in the space underlying the jet of an irrigator.

Tablets can be easily proportioned also by inexpert operators, and handling is easier and less risky for the health compared to liquids, as any direct contact with chemical substances is reduced. In the cases where tablets are used, it is sufficient to have a tank for fertilizing agents and/or active principles of a different type, as they are in the solid state and practically cannot be mixed. It is not necessary to provide a separate tank for every type of chemical substance. Mixing takes place only at the moment of use, that is, at the moment when the water flow through the tank is activated. This is particularly advantageous, in fact if different agents tend to slowly react together, this reaction can take place only at the moment when water is made to flow during an irrigation cycle, while in the case of different solutions used in an injection system, a reaction between different substances placed in a single container may take place even during the periods in which the irrigation plant is at rest.

Preferably, the fertilizing agent is selected from the group constituted by fertilizers and corrective agents or mixtures of the same. Advantageously, the active principle is selected from the group constituted by fungicides, bactericides, herbicides, insecticides, pesticides, biocides, repellents or mixtures of these. Fertilizing agents are especially preferred.

Fertilizers are substances that can be introduced into the ground in order to create, restore, preserve or increase the fertility of the ground with positive effects on plant growth. Fertilizers enrich the soil with one or more nutritional elements, while corrective agents shift the soil pH towards neutral or towards a value suitable for the plants to be grown. A repellent is any chemical substance or mixture useful to keep away a certain class of animals, for example voles or moles.

According to an advantageous embodiment of the invention, the inlet, the outlet and the inlet opening are carried out as fittings suited to be connected to connection pipes, in particular as threaded fittings or coupling fittings. Fittings of this type, which often on the market are also standardized, make it possible to create and vary an irrigation network according to the user's needs, without requiring expensive work or specific tools for assembling and disassembling said network.

According to a preferred embodiment of the invention, the tank comprises an elastic means, in particular a spring. In the presence of a tablet, the elastic means is suited to exert a force that presses the tablet. As the tablet dissolves, it may be advantageous to compact it or move it near the outlet and/or inlet of the tank in order to optimize the homogeneous dissolution of the same. If there are several tablets, the elastic means moves a new tablet into the place that was occupied by a tablet that has already dissolved. The elastic means thus helps move the tablets in the direction of the water flow.

The tank is preferably cylindrical. A cylindrical shape facilitates the stacking of different tablets that on the market are generally round. Experience has shown that it is the composition of the tablet, and more precisely the excipient used, that usually determines the order according to which the tablets dissolve. The position of the tablet in the stack of tablets and thus the position more or less deep into the direct flow of water from the inlet towards the outlet is less important in this context. The size of the tank can vary also according to the size of the tablets.

The shape of the tank and its size can vary without departing from the scope of the invention. Also the position of the inlet and the outlet can vary, in fact they can be on the same side, on opposite sides, at the same height in the tank or at different heights, at the bottom or at the top of the tank, for example even integrated in a possible closing element. The choice depends on the water flow that must be created inside the tank, on the position of the sprinkling unit with respect to the tank, etc. The different positions can be easily chosen by the person skilled in the art according to the needs and through simple construction modifications.

According to a particularly preferred embodiment of the invention, the irrigation system is an irrigator. If an irrigator (which according to the state of the art by definition comprises a sprinkling unit) already comprises also a tank, we have a compact, complete and efficient irrigation system according to the invention. In this case, the connection between sprinkling unit and tank is advantageously straight, without the intersection of further elements. The length of the connection is preferably selected in the order of millimeters or centimeters.

Advantageously, the sprinkling unit and/or the tank are buried into the ground in order to minimize environmental impact, in such a way that the jet and the closing element of the tank are accessible from the outside and that their upper surfaces are level with the ground. In this way, they do not represent an obstacle and cannot cause people to fall, nor hinder normal maintenance operations.

Advantageously, the system comprises also a check valve positioned upstream of the tank in order to prevent solutions containing a fertilizing agent and/or an active principle from polluting the water source.

A further aspect of the invention concerns an irrigation plant comprising:

(a) one or more tanks, each comprising

(a1) a water feeding inlet,

(a2) a water outlet, and

(a3) optionally, a closing element; and

(b) several sprinkling units, each comprising

(b1) a water feeding inlet opening, and

(b2) a water outlet jet,

wherein the several sprinkling units are connected in series and/or in parallel, preferably in series, and wherein the one or more tanks is or are positioned, with respect to the direction of the water flow, upstream of at least one of the sprinkling units, so that the water that feeds the at least one sprinkling unit flows through the tank before getting into the sprinkling unit, and wherein the several sprinkling units and the one or more tanks are preferably arranged according to at least one of the following layouts:

i) the plant comprises at least one tank that is arranged in the water flow direction, upstream of all the sprinkling units; and/or

ii) the plant comprises at least one tank that is arranged in the water flow direction, upstream of only one group of sprinkling units forming an irrigation sector of the plant; and/or

iii) the plant comprises at least one tank that is arranged in the water flow direction, upstream of a single sprinkling unit.

The connection of several sprinkling units with one or more tanks makes it possible to irrigate very large pieces of land at the same time. If a tank is positioned upstream of all the sprinkling units, all the sprinkling units receive the same type and the same quantity of fertilizing agent and/or of active principle and a uniform treatment is obtained for the entire piece of land involved. If a tank feeds only part of the sprinkling units, that is, only a group making up an irrigation sector of the plant, only the area where these sprinkling units are located receives the corresponding treatment. For other irrigation sectors formed by the sprinkling units within the irrigation plant according to the invention, a further tank can be selected that supplies another fertilizing agent and/or active principle. Other tanks can be left empty in order to supply water without any additions to the respective areas involved. If the tank remains empty, it does not hinder the normal irrigation operations in any way. If the number of tanks is increased in the case where many sprinkling units are used, the concentration of fertilizing agent and/or active principle can be increased, reducing the duration of the irrigation cycle. It is also possible to consider the possibility to connect several tanks in series, and this especially for the layouts from (i) to (iii) described above. With a tank before a single sprinkling unit, for example even before each one of the sprinkling units, it is possible to choose a suitable treatment for each single area of the ground. In addition to ensuring a uniform treatment of the soil, the irrigation plant according to the invention ensures a strictly individual treatment of the soil, a spot treatment or a treatment that covers different areas of the surface with different types of fertilizing agents and/or active principles, but also with different concentrations of the same if different tablets are placed in different tanks. A precisely targeted intervention is possible.

To treat small pieces of land, the layout i) is often sufficient, while for larger pieces of land the layout ii) and iii) can be selected.

Obviously, all the characteristics defined for the irrigation system and for its components can be transferred mutatis mutandis to the irrigation plant. The irrigation system according to the invention can be applied to the plant according to the invention.

Another aspect of the invention concerns an irrigation method comprising the following steps:

(a) making water flow from a water source through a tank containing at least one tablet comprising a fertilizing agent and/or an active principle essentially soluble in water, thus producing an aqueous solution of the fertilizing agent and/or active principle;

b) conveying the aqueous solution into a sprinkling unit.

This method according to the invention expresses the concept of the irrigation system according to the invention in the form of a process. The characteristics defined above for the irrigation system and the irrigation plant and their components can be integrated into or transferred mutatis mutandis to the method according to the invention. The irrigation system and plant according to the invention can be used in the irrigation method according to the invention.

A further aspect of the invention concerns a dispenser tank comprising (a) a water feeding inlet, (b) a water outlet, optionally a closing element, wherein the tank contains at least one tablet comprising an active principle and/or a fertilizing agent essentially soluble in water, wherein the fertilizing agent is preferably selected from the group consisting of fertilizers and corrective agents or mixture of these, and the active principle is preferably selected from the group consisting of fungicides, bactericides, herbicides, insecticides, pesticides, biocides and repellents or mixtures of these.

The size of the dispenser tank can be different depending on its intended use. It will be larger if it must be used for the entire plant and smaller if it feeds one irrigator only or a group of irrigators, that is, a sector of the irrigation plant.

The dispenser tank according to the invention can be used in the irrigation system, plant and method according to the invention and therefore can have all the characteristics described for the tank with reference to the irrigation system, plant and method.

The last aspect of the invention concerns the use of the irrigation system, irrigation plant, irrigator, dispenser tank and irrigation method according to the invention to treat a golf course, a garden, a meadow, a lawn, a football ground, a tennis court, an agricultural area, a vineyard, a market garden, a plantation, a nursery garden or a fruit orchard with a fertilizing agent and/or an active principle. The use of the objects described above is substantially possible on all types of soil.

Variant embodiments of the invention are the subject matter of the dependent claims. The description of preferred examples of embodiment of the irrigation system, irrigation plant, irrigation method, dispenser tank according to the invention and of their use according to the invention is provided by way of non-limiting example with reference to the attached drawings.

### BRIEF DESCRIPTION OF THE SEVERAL VIEWS OF THE DRAWINGS

FIG. 1 shows a cross-sectional view of a first example of embodiment of an irrigation system according to the invention;

FIG. 2 shows the tank shown in FIG. 1 with a helical spring;

FIGS. 3a to 3c show cross-sectional views of different examples of embodiment for the arrangement of the inlet and outlet in tanks of the irrigation system according to the invention;

FIG. 4 shows a cross-sectional view of how an example of embodiment of the tank of the irrigation system according to the invention is positioned in the ground;

FIG. 5a shows an irrigation plant of the state of the art and FIGS. from 5b to 5d schematically show some examples of embodiment of irrigation plants according to the invention in which the arrangement of the tanks and sprinkling units inside the plant changes.

### DETAILED DESCRIPTION OF THE INVENTION

With reference to FIG. 1, it is possible to observe an irrigation system indicated as a whole by 2. The irrigation system 2 comprises a tank 4 that in its turn is provided with an inlet 6 and an outlet 8. Furthermore, the tank is provided with a closing element 10 that can be opened in order to introduce a tablet 12 in the tank 4. The irrigation system 2 is integrated with a sprinkling unit 14. The sprinkling unit 14 comprises an inlet opening 16 and a jet 18.

Both the tank 4 and the sprinkling unit 14 can have different shape and dimensions, and also the arrangement of the openings 6, 8, 16 and 18, for example, can be different. The flow of water, indicated by the reference number 20, shows that the water flows first through the tank 4, getting in through the inlet 6 and out through the outlet 8. Flowing through the tank 4, the water dissolves at least part of the tablet 12 and when it flows out through the outlet 8 it is enriched with one or more fertilizing agents and/or active principles contained in the tablet 12. From here it moves, through the inlet opening 16, into the sprinkling unit 14 and flows out of the latter through the jet 18 in order to irrigate and treat the soil (not illustrated herein).

The connection 7 between the tank 4 and the sprinkling unit 14 is just hinted at and it can be a direct connection, but also an indirect connection in which, for example, further pipes with sprinkling units, valves, other tanks, etc. can be inserted between the tank 4 and the sprinkling unit 14.

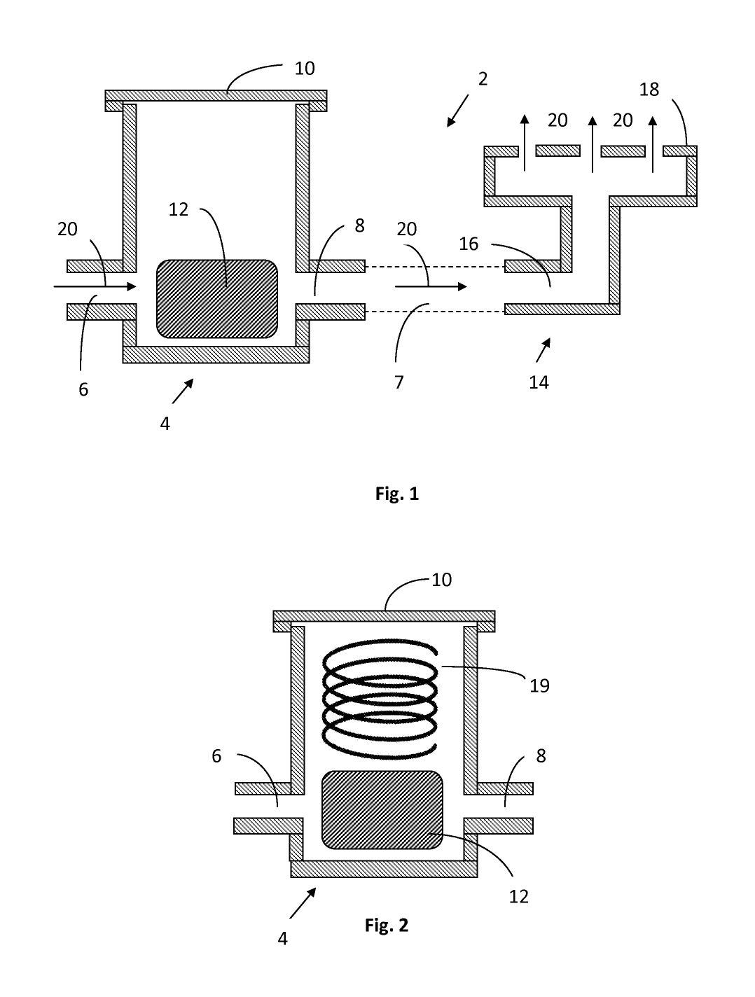

FIG. 2 shows that the tank 4 of the irrigation system 2 shown in FIG. 1 can furthermore contain an elastic means, in this case a helical spring 19, which serves to keep the tablet 12 in its position even after it has partially dissolved. For this purpose, other devices performing the same function of keeping the tablet 12 in a given position can be devised.

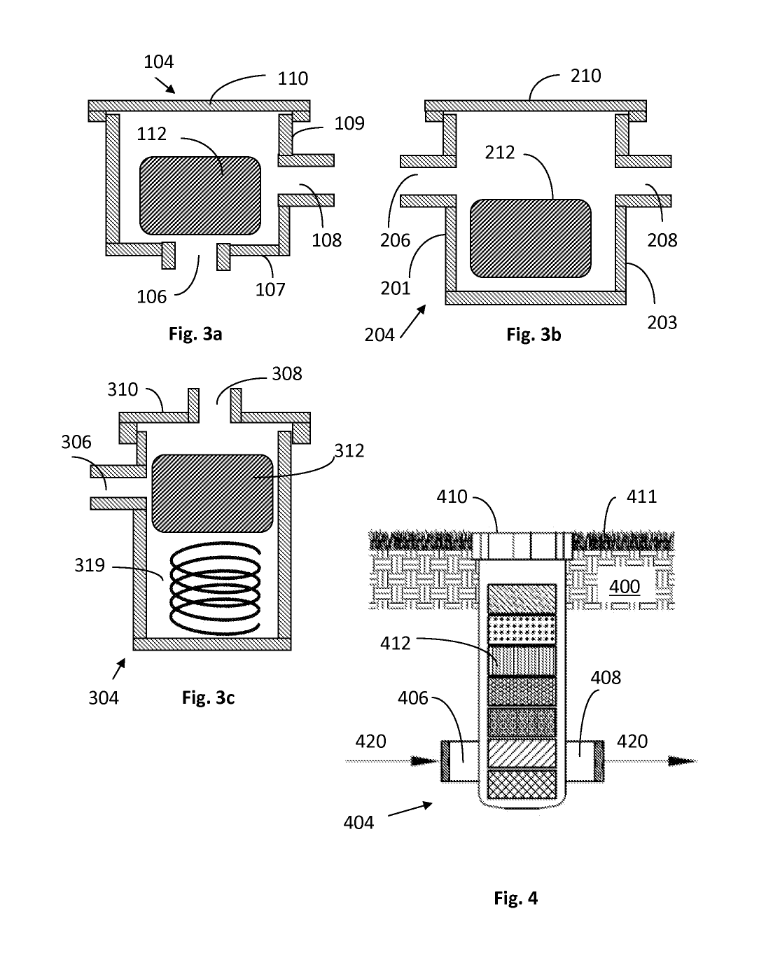

FIGS. 3a to 3c show an exemplary series of tanks 104, 204 and 304 suited to be used in a system according to the invention. In the version indicated by the reference number 104 in FIG. 3a, the inlet 106 is on the bottom 107 of the tank 104, while the outlet 108 is positioned in a wall 109 of the tank. In the version 204, illustrated in FIG. 3b, the inlet 206 and the outlet 208 are situated on opposite sides 201 and 203 at the same height. In the version 304 shown in FIG. 3c, finally, the inlet 306 is made laterally in an upper portion of the tank 304, while the outlet 308 is made in the cover 310 of the tank 304. Obviously, the position of the inlet and the outlet inside the tank can vary further according to construction needs, to the connection with the sprinkling unit and the water source, to the installation in irrigation plants, and in order to manage the flow in a way suited to reach specific speeds of dissolution of the tablets that are placed inside the tank. The inlets 106, 206 and 306 may even be inverted with the corresponding outlets 108, 208 and 308. All the tanks shown in FIGS. 3a to 3c comprise a cover, respectively 110, 210 and 310, and a tablet, respectively 112, 212 and 312. In the particular case of the tank 304, this comprises also a helical spring 319 intended to maintain the tablet 312 in the water flow between the inlet 306 and the outlet 308.

FIG. 4 shows an example of embodiment of a tank 404 of an irrigation system according to the invention, in which the tank 404 is buried in the ground, so that the top of the tank is level with the surface 411 of the ground 400. The tank 404 is provided with an inlet 406, an outlet 408 and a cover 410. In the tank 404 there are seven tablets 412 that can be of the same type or of a different type. The water follows the direction indicated by the arrow 420. The buried irrigation system has a very limited environmental impact. The cover 410 makes it possible to fill the tank 404 with no need to remove and/or disassemble it. The tank 404 can be connected to a sprinkling unit (not illustrated herein) through a direct connection, and the connection can be of a different type: a rigid pipe or a flexible pipe suitably connected with its ends to the outlet 408 of the tank and to the inlet opening of a sprinkling unit (not illustrated herein). The connection can be a fixed connection or a removable connection in which the connection unit and the corresponding inlets and outlets of the tank and the sprinkling units are provided with fittings suited to connect the single components to one another, as is known in the field of agriculture and gardening.

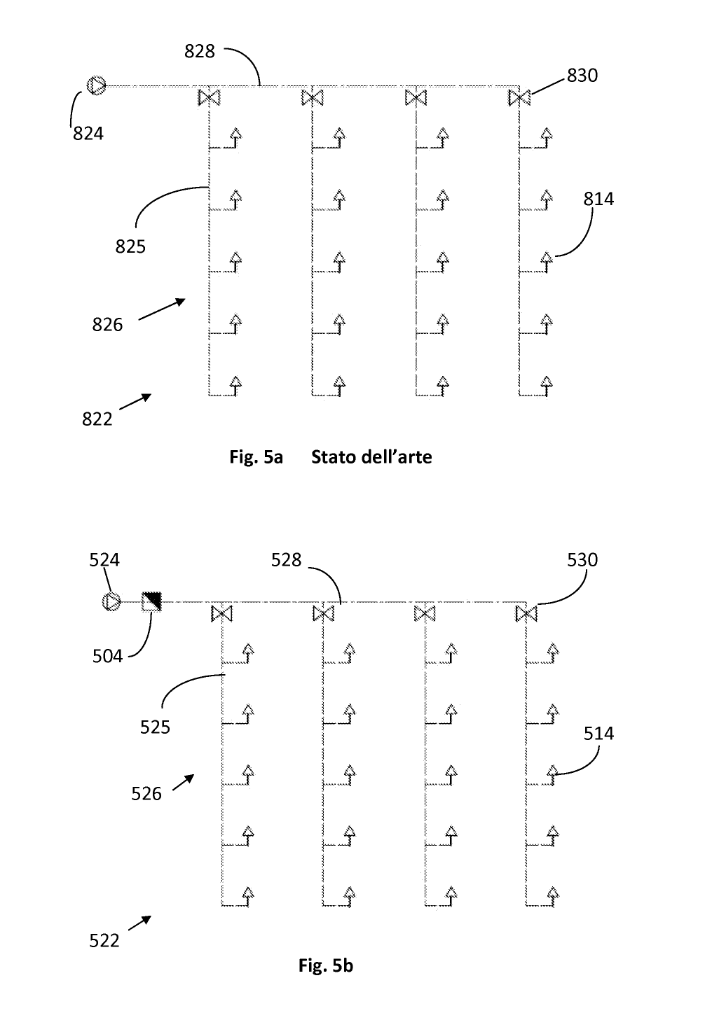

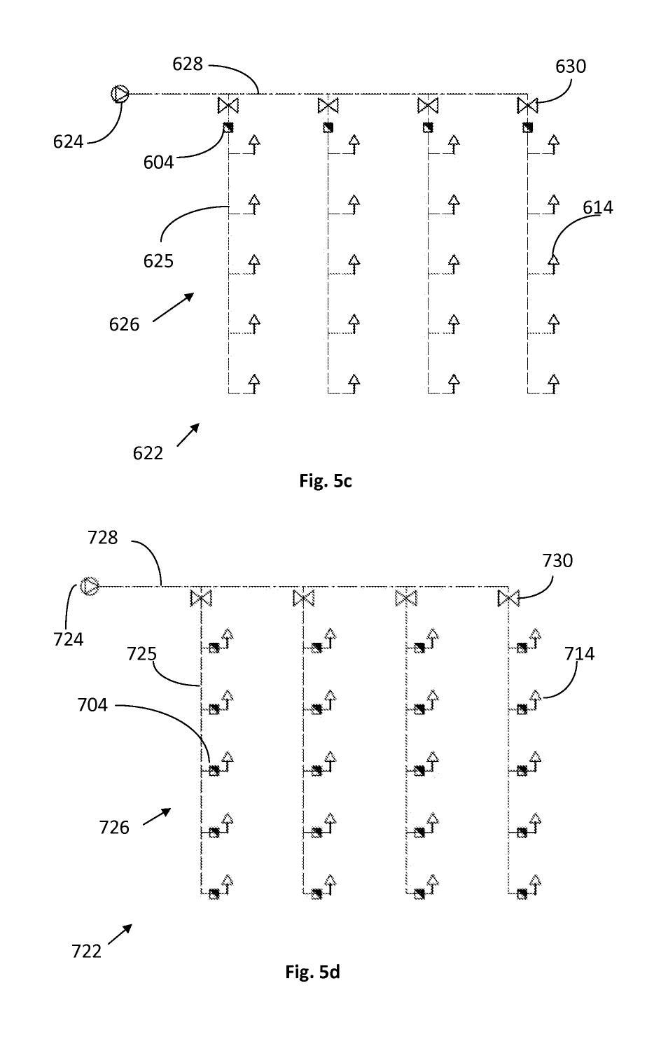

FIG. 5a has already been described in the explanation concerning the state of the art. FIGS. 5b to 5d show in schematic diagrams some irrigation plants according to the invention indicated as a whole respectively by 522, 622 and 722. In FIG. 5b a separable water feeding device is indicated by the reference number 524. The water passes through a tank 504 containing a tablet with an active principle and/or a fertilizing agent (not illustrated herein). Downstream of the tank, the plant is provided with a series connection of several sets of sprinkling units 514 that form an irrigation sector 526 of the plant, wherein each sector 526 consists of five sprinkling units 514 arranged in series along a secondary pipe 525 that departs from the main pipe 528. Each set 526 can be separated from the main pipe 528 through a valve 530. The number of the sprinkling units 514, of the sets 526, and the connection of these with each other may vary according to the needs of the soil to be treated. The irrigation plant 522 supplies all the connected sprinkling units 514 with a solution having the same composition and concentration. Such a plant, for example, is suitable for small pieces of land that must be treated in a uniform way.

FIG. 5c, on the other hand, illustrates an irrigation plant 622 with the same components (water feeding device 624, tanks 604, sprinkling units 614 and valves 630, a main pipe 628 and some secondary pipes 625) of the plant shown in FIG. 5b. Differently from the plant 522, the plant 622 has no tank upstream of all the sprinkling units, but a tank 604 upstream of each set 626 of sprinkling units 614. In this way, the user can decide to fill the tanks 604 with different active principles and/or fertilizing agents or to leave one or more tanks empty. In this way, it is possible to treat different areas of the ground in different ways, for example if this is required by the non-homogeneous chemical structure of the ground.

FIG. 5d, finally, illustrates an irrigation plant 722 that is suitable for spot treatments. Mainly, the components and the network of pipes (water feeding device 724, tanks 704, sprinkling units 714, valves 730, secondary pipes 725 and main pipe 728) correspond to those shown in FIGS. 5a to 5c. In the plant 722 each sprinkling unit 714 is provided with a tank 704. This concept makes it possible to obtain an even more customised treatment of different areas of the ground.

Other embodiments of the plant according to the invention, not illustrated herein, can be considered as possible alternatives, for example combinations of the versions shown in FIGS. 5b to 5d. The presence and the installation of the valves depend on the needs of the expert in the art, as well as the possible use of check valves before each tank, aimed at avoiding the return of water with the addition of an active principle and/or a fertilizing agent towards the water source.

The invention has achieved the object to provide an irrigation system that overcomes the drawbacks described above with regard to the irrigation systems of the state of the art, is simple from a construction point of view and does not require complex structures to add suitable quantities of fertilizing agents and/or active principles, like insecticides, herbicides, etc. to the irrigation water. The invention furthermore offers several advantages as described above. The invention has also achieved the object to provide a corresponding irrigation plant and irrigation method, and proposes a dispenser tank and different uses of the irrigation system, plant, method, and of the dispenser tank.

In the implementation phase, the irrigation system, plant and method, the dispenser tank and their uses, which are all the subject of the present invention, can be subjected to further modifications or changes that are not described herein. These modifications and the resulting variant embodiments must all be considered protected by the present patent, provided that they fall within the scope of the claims expressed below.

1. An irrigation system, in particular an irrigator, comprising:
(a) a tank comprising
(a1) a water feeding inlet,
(a2) a water outlet, and
(a3) optionally a closing element;
(b) a sprinkling unit comprising
(b1) a water feeding inlet opening,
(b2) a water outlet jet; and
(c) a connection element suited for transferring a liquid,
wherein said inlet opening of said sprinkling unit is connected with said outlet of said tank, in the direction of said water flow being fed, downstream of said tank, through said connection element, so that the water flowing out of said tank enters said sprinkling unit through said inlet opening.

2. The irrigation system according to claim 1, characterized in that said sprinkling unit is connected to said tank in such a way that said sprinkling unit is fed only by the water flowing out of said tank.

3. The irrigation system according to claim 1, characterized in that said tank contains at least one tablet comprising an active principle and/or a fertilizing agent which is essentially soluble in water.

4. The irrigation system according to claim 3, characterized in that said fertilizing agent is selected from the group consisting of fertilizers and corrective agents or mixtures of these, and in that said active principle is selected from the group consisting of fungicides, bactericides, herbicides, insecticides, pesticides, biocides and repellents or mixtures of these.

5. The irrigation system according to claim 1, characterized in that said inlet, said inlet opening and said outlet are made as fittings suited to be connected to connection pipes, in particular as threaded fittings or coupling fittings.

6. An irrigation plant comprising:
(a) one or more tanks, each comprising
(a1) a water feeding inlet,
(a2) a water outlet, and
(a3) optionally a closing element; and
(b) several sprinkling units, each comprising
(b1) a water feeding inlet opening, and
(b2) a water outlet jet,
wherein said several sprinkling units are connected in series and/or in parallel, preferably in series, and wherein said one or more tanks are situated, with respect to the water flow direction, upstream of at least one of said sprinkling units, so that the water feeding said at least one sprinkling unit flows through said tank before entering said sprinkling unit, and wherein said several sprinkling units and said one or more tanks are preferably arranged so that the plant comprises at least one tank which is situated in the water flow direction, upstream of only one sprinkling unit.

7. An irrigation plant according to claim 6 wherein said one or more tanks is arranged so that the plant comprises at least one tank which is situated in the water flow direction, upstream of all of the sprinkling units.

8. An irrigation plant according to claim 6 wherein said one or more tanks is arranged so that the plant comprises at least one tank which is situated in the water flow direction, upstream of only one group of sprinkling units forming an irrigation sector of the plant.

9. An irrigation method comprising the following steps:
(a) making water flow from a water source through a tank which contains at least one tablet comprising a fertilizing agent and/or an active principle essentially soluble in water, so as to form an aqueous solution of said fertilizing agent and/or said active principle; and
(b) conveying said aqueous solution into a sprinkling unit.

10. The irrigation method according to claim 9 further comprising (c) treating a golf course, a garden, a meadow, a lawn, a football ground, a tennis court, an agricultural area, a vineyard, a market garden, a plantation, a nursery garden or a fruit orchard with said aqueous solution through said sprinkling unit.
